(19) United States
(12) Patent Application Publication
(10) Pub. No.: US 2025/0056275 A1
(43) Pub. Date: Feb. 13, 2025

(54) DUAL MODE ASSET MANAGEMENT

(71) Applicant: Troverlo, Inc., College Station, TX (US)

(72) Inventor: Cody William Catalena, College Station, TX (US)

(21) Appl. No.: 18/925,420

(22) Filed: Oct. 24, 2024

Related U.S. Application Data
(63) Continuation of application No. PCT/US2024/031424, filed on May 29, 2024.
(60) Provisional application No. 63/469,908, filed on May 31, 2023.

(51) Int. Cl. H04W 24/08; H04W 4/029; H04W 84/12; H04W 88/08

(52) U.S. Cl. CPC H04W 24/08; H04W 4/029; H04W 84/12; H04W 88/08

(57) ABSTRACT

A method of dual mode asset management includes a dual mode supervisor that configures one or more computing resources of a dual mode asset to directly report asset related data to a dual mode database over a network connection to the Internet while the dual mode asset is in an online mode of operation and configures a Wi-Fi interface of the dual mode asset to broadcast beacon frames comprising asset related data while the dual mode asset is in an offline mode of operation with no network connection to the Internet. The offline mode of operation relies upon Troverlo, Inc.'s passive asset or sensor tracking to indirectly report the asset related data to the dual mode database by way of location services. In an dual mode of operation, dual mode supervisor configures the dual mode asset to perform two or more of directly report, scan, and beacon simultaneously.

### CROSS REFERENCE TO RELATED APPLICATIONS

This application is a continuation of PCT International Application PCT/US2024/031424, filed on May 29, 2024, which claims the benefit of, or priority to, U.S. Provisional Patent Application Ser. No. 63/469,908, filed on May 31, 2023, both of which are hereby incorporated by reference in their entirety for all purposes.

### FIELD OF INVENTION

The present disclosure relates to systems and methods for locating, monitoring, managing, and obtaining data from assets when they are in an online mode connected to the Internet and also when they are in an offline mode disconnected from the Internet.

### BACKGROUND OF THE INVENTION

Individuals and organizations responsible for the oversight and management of assets face many challenges that frustrate their ability to effectively locate, monitor, and obtain data from these assets once they have been deployed in the field. The types or kinds of assets under management are broad, encompassing any items that are desired to be managed, ranging from relatively small and inexpensive items to large and expensive capital machinery. The ability to manage such assets is further complicated by the fact that these assets may move freely from one location to another.

In simple cases, the movement of assets may be confined to a small geographic area under the control of the individual or organization responsible for their management, substantially simplifying the management task. In more complex cases, the assets may move freely anywhere in the world, well beyond the sphere of influence and control of the individual or organization responsible for their management.

While the ability to locate, monitor, and obtain data from assets that have communication capabilities and network connectivity is feasible, it remains an expensive and complicated endeavor. These difficulties are compounded by the type, kind, and number of assets being managed, the environment in which the assets are disposed, and the scale of the geographic area over which the assets are to be managed. Notwithstanding, assets are routinely deployed into environments where they do not have network connectivity. Once these assets are deployed in the field, they are typically never heard from again.

### BRIEF SUMMARY OF THE INVENTION

According to one aspect of one or more embodiments of the present invention, a method of dual mode asset management includes a dual mode supervisor that configures one or more computing resources of a dual mode asset to directly report asset related data to a dual mode database over a network connection to the Internet while the dual mode asset is in an online mode of operation and configures a Wi-Fi interface of the dual mode asset to broadcast beacon frames comprising asset related data while the dual mode asset is in an offline mode of operation with no network connection to the Internet. The offline mode of operation relies upon Troverlo, Inc.'s passive asset or sensor tracking to indirectly report the asset related data to the dual mode database by way of location services.

According to one aspect of one or more embodiments of the present invention, a non-transitory computer-readable medium comprising software instructions that, when executed by a processor, performs a method of dual mode asset management includes a dual mode supervisor that configures one or more computing resources of a dual mode asset to directly report asset related data to a dual mode database over a network connection to the Internet while the dual mode asset is in an online mode of operation and configures a Wi-Fi interface of the dual mode asset to broadcast beacon frames comprising asset related data while the dual mode asset is in an offline mode of operation with no network connection to the Internet. The offline mode of operation relies upon Troverlo, Inc.'s passive asset or sensor tracking to indirectly report the asset related data to the dual mode database by way of location services.

According to one aspect of one or more embodiments of the present invention, a dual mode asset includes a plurality of computing resources including a processor, a storage device, a network interface device, a Wi-Fi interface, and a power supply, a dual mode supervisor including software instructions that, when executed by the processor configures one or more computing resources of the dual mode asset to directly report asset related data to a dual mode database over a network connection to the Internet while the dual mode asset is in an online mode of operation, and configures the Wi-Fi interface of the dual mode asset to broadcast beacon frames including asset related data while the dual mode asset is in an offline mode of operation with no network connection to the Internet. The offline mode of operation relies upon Troverlo, Inc.'s passive asset or sensor tracking to indirectly report the asset related data to the dual mode database by way of location services.

According to one aspect of one or more embodiments of the present invention, a dual mode asset management system includes a dual mode asset including a plurality of computing resources including a processor, a storage device, a network interface device, a Wi-Fi interface, and a power supply, a dual mode supervisor including software instructions that, when executed by the processor configures one or more computing resources of the dual mode asset to directly report asset related data to a dual mode database over a network connection to the Internet while the dual mode asset is in an online mode of operation, and configures the Wi-Fi interface of the dual mode asset to broadcast beacon frames comprising asset related data while the dual mode asset is in an offline mode of operation with no network connection to the Internet. The offline mode of operation relies upon passive asset or sensor tracking to indirectly report the asset related data to the dual mode database by way of location services. The system further includes a dual mode database accessible via the Internet that directly receives reports of asset related data from the dual mode asset while the dual mode asset is in the online mode of operation, and indirectly receives reports of asset related data from the dual mode asset via location services while the dual mode asset is in the offline mode of operation.

Other aspects of the present invention will be apparent from the following description and claims.

### BRIEF DESCRIPTION OF THE DRAWINGS

FIG. 1A shows an example of conventional short-range asset tracking system using an asset tag that is scanned by a dedicated asset tag reader that self-determines and self-reports its location as a proxy for the location of the asset tag.

FIG. 1B shows an example of conventional GPS-based asset tracking system using a GPS-enabled asset that self-determines its current location based on one or more GPS satellite signals and self-reports its location.

FIG. 2A shows an example of conventional Wi-Fi location determination where a wireless device uses information about in-range Wi-Fi access points to self-determine its current location.

FIG. 2B shows an example of conventional location determination of a wireless device using one or more of GPS location determination, Wi-Fi location determination, and location services.

FIG. 3A shows a diagram of a conventional Wi-Fi wireless network discovery protocol between a wireless device and a Wi-Fi access point that underlies Wi-Fi location determination.

FIG. 3B shows a diagram of a conventional Wi-Fi management frame used as part of the conventional Wi-Fi wireless network discovery protocol.

FIG. 3C shows a diagram of Troverlo, Inc.'s passive asset or sensor tracking using observations of a Wi-Fi access point associated with an asset and location services.

FIG. 3D shows a diagram of a Wi-Fi management frame with custom data added in a programmable field as part of Troverlo, Inc.'s passive asset or sensor tracking.

FIG. 4 shows a diagram of a dual mode asset in accordance with one or more embodiments of the present invention.

FIG. 5 shows a method of dual mode asset management in accordance with one or more embodiments of the present invention.

FIG. 6 shows a schematic of a computing system in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are described to provide a thorough understanding of the present invention. In other instances, aspects that are well-known to those of ordinary skill in the art are not described to avoid obscuring the description of the present invention.

The design of an asset management system is influenced by a number of factors including, for example, the number of assets to be managed, the size of the geographic area in which they are to be managed, the implementation costs, and the constraints imposed by the environment in which the assets are expected to travel. In many real-world situations, it is not economically feasible, or technologically possible, to implement an effective asset management system using conventional asset management technologies.

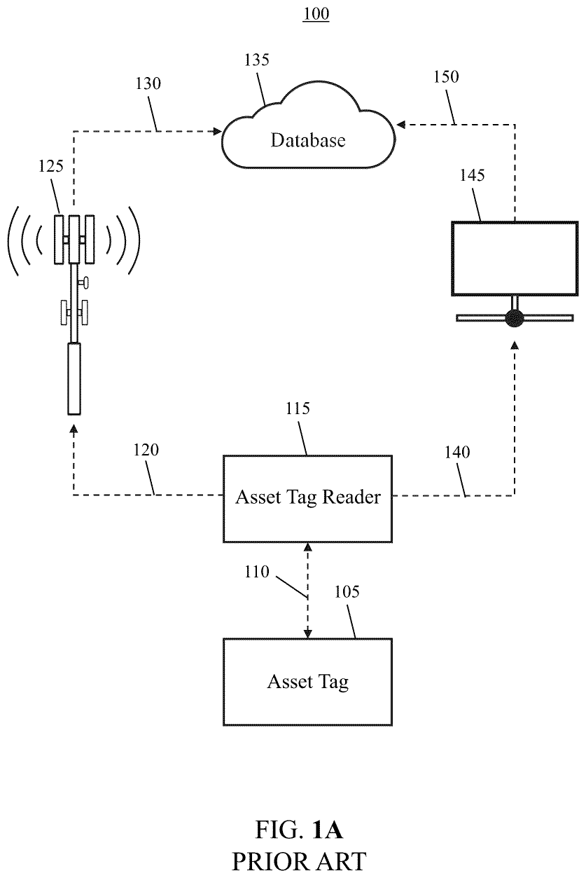

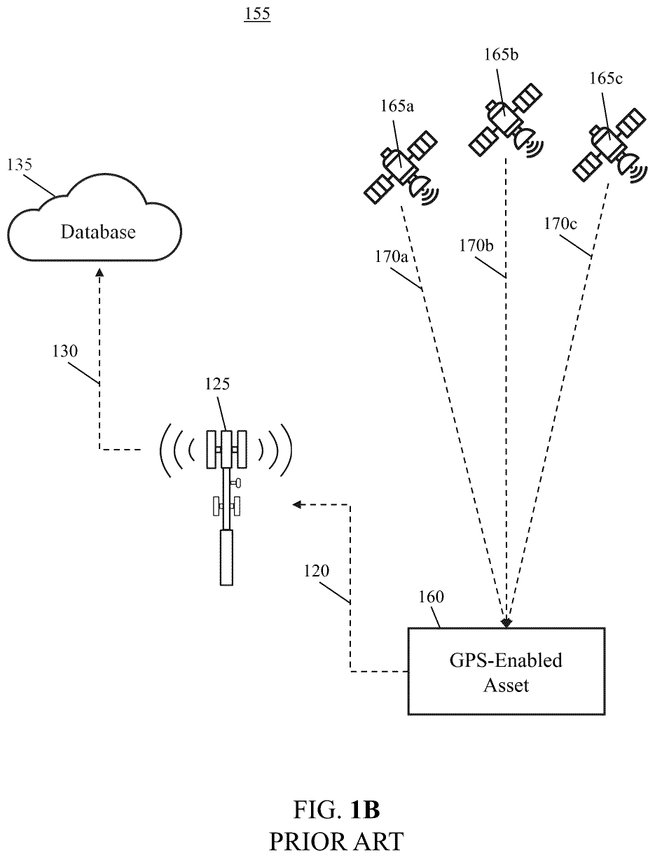

FIG. 1A shows an example of conventional short-range asset tracking system 100 using an asset tag 105 that is scanned by a dedicated asset tag reader 115 that self-determines and self-reports its location as a proxy for the location of asset tag 105.

Conventional short-range asset tracking system 100 uses asset tags 105 that are configured to be read by asset tag readers 115 that are brought into signaling proximity of asset tags 105 using, for example, Radio-Frequency Identification (“RFID”), Near-Field Communications (“NFC”), Bluetooth Low Energy (“BLE”), Ultra-Wideband (“UWB”), or other short-range communications technologies that are well known in the art. When a dedicated asset tag reader 115 is brought within sufficiently close signaling range of asset tag 105 so as to enable short-range communications, asset tag reader 115 reads identification information of asset tag 105 via short range signaling 110. While asset tags 105 are typically implemented as low cost adhesive tags and do not have the ability to self-determine or self-report their current location, asset tag reader 115 has the ability to self-determine its current location through one or more of GPS location determination (not shown), Wi-Fi location determination (not shown), network location determination (not shown), or any other location determination technique that are well known in the art. As such, once asset tag reader 115 is brought into signaling range of asset tag 105, asset tag reader 115 reads asset tag 105, self-determines its own location at or near the time of scanning, and reports its current location as a proxy for the current location of asset tag 105 to remote database 135 over a network connection.

In certain applications, the network connection may include a cellular connection 120 between asset tag reader 115 and cellular tower 125, which is connected to the Internet by way of backhaul connection 130, ultimately providing asset tag reader 115 access to remote database 135. In other applications, the network connection may include a wired or wireless network connection 140 between asset tag reader 115 and an intermediate computer 145 or Wi-Fi access point (not shown) that includes a wired or wireless connection 150 to the Internet, ultimately providing asset tag reader 115 access to remote database 135. In still other applications, asset tag reader 115 may read and store the identifying information of asset tags 105 that it encounters as well as its own self-determined location at the time of scanning for offloading to remote database 135 at a later time.

While the type or kind of network connection or connections may vary based on an application or design, a short-range asset tracking system 100 requires a dedicated asset tag 105 for each asset to be tracked and a dedicated asset tag reader 115 that must be brought within signaling range of asset tag 105, where asset tag reader 115 has the ability to self-determine and self-report its own current location as a proxy for the current location of asset tag 105 and by extension the asset it is adhered to.

Continuing, FIG. 1B shows an example of conventional GPS-based asset tracking system 155 using a GPS-enabled asset 160 that self-determines its current location based on one or more GPS satellite (e.g., 165a, 165b, 165c) signals (e.g., 170a, 170b, 170c) and self-reports its current location to a remote database 135 over a network connection (e.g., 120, 125, 130).

Conventional GPS-based asset tracking 155 includes one or more GPS-enabled assets 160, a plurality of GPS satellites (e.g., 165a, 165b, and 165c) in Earth orbit, a network connection (e.g., 120, 125, 130), and a remote database 135 accessible via the network connection. GPS-enabled asset 160 includes a GPS receiver (not shown) capable of receiving one or more GPS satellite (e.g., 165a, 165b, 165c) signals (e.g., 170a, 170b, and 170c) from one or more overhead GPS satellites (e.g., 165a, 165b, and 165c) that are used by GPS-enabled asset 160 to self-determine its current location using one or more well known GPS positioning techniques. Once GPS-enabled asset 160 has self-determined its current location, it self-reports its current location to remote database 135 via the network connection.

GPS-enabled asset 160 includes a communication module (not shown) capable of transmitting the current location of GPS-enabled asset 160 to remote database 135 via the network connection (e.g., 120, 125, 130). In example depicted, the network connection may be cellular connection 125 between GPS-enabled asset 160 and cellar tower 120, which is connected to the Internet by way of backhaul connection 130, ultimately providing GPS-enabled asset 160 access to remote database 135.

While the type or kind of network connection or connections may vary based on an application or design, a GPS-enabled asset 160 self-determines and self-reports its own current location to remote database 135 via one or more network connections. For these reasons, GPS-based asset tracking 160 imposes substantial costs as each and every asset 160 to be tracked, requires a dedicated power supply (not shown), a GPS receiver (not shown), and communication capabilities (not shown) sufficient to transmit data over a network connection to remote database 135. Notwithstanding, because of incompatibilities between cellular communication technologies used around the world (e.g., frequencies, standards, operator specific implementations), the ability of a GPS-enabled asset 160 to self-report its self-determined location can be frustrated if the asset 160 happens to be located in an area where it is not compatible the local cellular system.

The conventional asset tracking systems discussed above may be referred to as active asset tracking systems because they require dedicated hardware and software that are purposefully deployed throughout the zone of coverage to engage in the asset tracking task. This requires a substantial investment in expensive hardware, software, and personnel. Moreover, in a widespread deployment of assets that potentially spans the world, due to inherent complexity and expense, it is virtually impossible to implement an effective active asset tracking system. This is in contrast to Troverlo, Inc.'s passive asset or sensor tracking that is discussed herein.

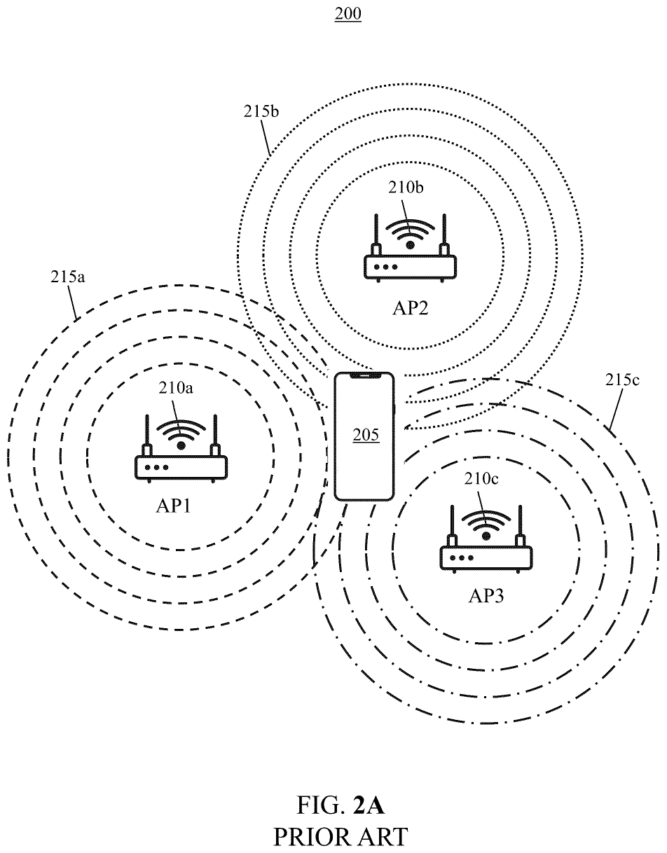

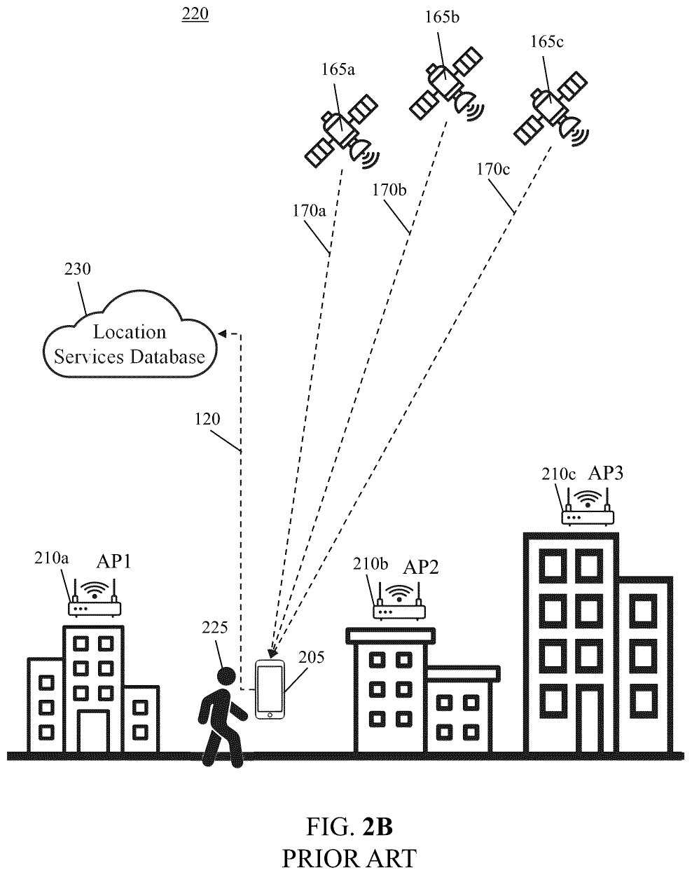

FIG. 2A shows an example of conventional Wi-Fi location determination 200 where a wireless device 205 uses information about in-range (e.g., 215a, 215b, 215c) Wi-Fi access points (e.g., 210a, 210b, 210c) to self-determine its current location.

Many applications that we use on a daily basis, including for example, mapping, navigation, drive share, and delivery applications, rely on the ability of wireless device 205 to accurately determine its current location. While determining the location of wireless device 205 by way of GPS is very fast and inexpensive, there is inherent uncertainty in the location determination and sometimes there are physical obstructions that prevent wireless device 205 from receiving sufficient GPS satellite signal to precisely determine its location.

For this reason, the operating system of wireless device 205 includes a set of features commonly referred to as location services (not shown) that are used to enhance the precision of GPS location determinations or make a location determination in the absence of sufficient GPS signal reception. Location services (not shown) refers generally to software, typically part of the operating system, executing locally on wireless device 205 as well as a remote location services database (not shown) that maintains a list of Wi-Fi access points around the world and their respective last known locations. When wireless device 205 requests location services, the operating system may report information relating to Wi-Fi access points 210a, 210b, 210c in signaling range 215a, 215b, 215c of wireless device 205 to its remote location services database (not shown) and obtain information from the remote location services database (not shown) relating to the last known locations of these Wi-Fi access points 210a, 210b, 210c. Wireless device 205 may then use this information and one or more well known positioning techniques including, for example, Received Signal Strength Indicator (“RSSI”), fingerprinting, Angle of Arrival (“AoA”), Time of Flight (“ToF”), Monte Carlo Sampling, or any others to self-determine its current location.

In order to implement Wi-Fi location determination, you must recognize that the ecosystem of Wi-Fi access points deployed around the world is dynamic and constantly changing. New Wi-Fi access points may be put into service, some Wi-Fi access points may be taken out of service, and some Wi-Fi access points may be moved from one location to another. As such, the data in the remote location services database(s) (not shown) maintained by the original equipment manufacturers (“OEMs”) of the operating system of the wireless device 205, including, for example, those maintained by Apple®, Google®, Qualcomm®, and other third party maintained databases, is dynamic and constantly changing. In order for location services to function as intended, the remote location services database(s) (not shown) must be constantly updated.

To that end, the existing ecosystem of wireless devices (e.g., 205) in use around the world, observe and report observations of Wi-Fi access points (e.g., 210a, 210b, 210c) that they encounter to their respective remote location services database (not shown), typically maintained by the OEM of the operating system of wireless device 205, including, for example, those maintained by Apple®, Google®, Qualcomm®, and other third party maintained databases. While this feature is used by every wireless device 205 around the world, the user is typically not aware that this is taking place, because the observing and reporting of observations of Wi-Fi access points (e.g., 210a, 210b, 210c) to its remote location services database (not shown) happens entirely in the background of the operating system of wireless devices 205, without notification to, participation by, or even awareness on the part of the user of wireless device 205 that this is taking place.

Continuing, FIG. 2B shows an example of conventional location determination 220 of a wireless device 205 using one or more of GPS location determination, Wi-Fi location determination, and location services.

While wireless device 205 typically includes a GPS receiver configured to receive GPS satellite (e.g., 165a, 165b, 165c) signals (e.g., 170a, 170b, 170c) that are used to self-determine its current location, weather, structures, and other obstructions can frustrate the ability of wireless device 205 to self-determine its current location or reduce the accuracy of the location determination. Wi-Fi location determination (e.g., 200) may be used by wireless devices 205 to refine the accuracy of a GPS location determination or determine the current location of wireless device 205 in the absence of sufficient GPS signal reception.

For example, user 225 of wireless device 205 walking in a downtown area may open a mapping application to determine their current location or get directions to a specific destination. Wireless device 205 includes a GPS receiver (not shown) that receives GPS satellite (e.g., 165a, 165b, 165c) signals (e.g., 170a, 170b, 170c) that may be used to determine the location of wireless device 205. However, obstructions, such as, for example, tall buildings, may prevent line-of-sight access to one or more GPS satellites (e.g., 165a, 165b, 165c) and the GPS location determination may have a substantial amount of uncertainty or fail entirely. In the example depicted, wireless device 205 may only be able to resolve that it is located somewhere on or near Main Street but cannot determine its precise location with the requisite degree of accuracy to determine its current address. In such a situation, Wi-Fi location determination and location services may be used by wireless device 205 to enhance the GPS location determination or determine the location in the absence of sufficient GPS signal reception.

User 225 is likely not aware that while he is walking through the downtown area, his wireless device 205 encounters various Wi-Fi access points (e.g., 210a, 210b, 210c), receives and records information from each Wi-Fi access point (e.g., 210a, 210b, 210c) encountered, and covertly reports observations of those encounters to its respective location services database 230, typically maintained by the OEM of the operating system of wireless device 205, including, for example, those maintained by Apple®, Google®, Qualcomm®, and other third party maintained databases. Location services database 230 uses this information to update its list of Wi-Fi access points and their last known locations for future use by other users of location services. Wireless device 205 may report, for example, its current location, the unique identifying information of each Wi-Fi access point 210a, 210b, 210c encountered, their respective received signal strengths, and potentially other information, without requiring authentication to, or association with, any Wi-Fi access point 210a, 210b, 210c encountered. Location services database 230 may use this information and other reported observation data to determine a location for each Wi-Fi access point and update its respective listing in the database. In the example depicted, wireless device 205 encounters Wi-Fi access points 210a, 210b, and 210c and reports observations of those encounters to location services database 230, without user 225 awareness that this is taking place in the background of the operating system of their own wireless device 205.

At this point, wireless device 205 may have a GPS location determination that lacks precision, but has information regarding nearby Wi-Fi access points 210a, 210b, and 210c it has encountered, and their respective received signal strengths, and may request additional information from location services database 230 such as, for example, the last known locations of nearby Wi-Fi access points 210a, 210b, and 210c. Wireless device 205 may then use any information available to it and well known positioning techniques to enhance the GPS location determination or self-determine its current location in the absence of sufficient GPS signal reception. The scenario depicted represents the conventional use of Wi-Fi location determination and location services to enhance or determine the location of wireless device 205, without the participation of, or awareness on the part of, user 225 of wireless device 205.

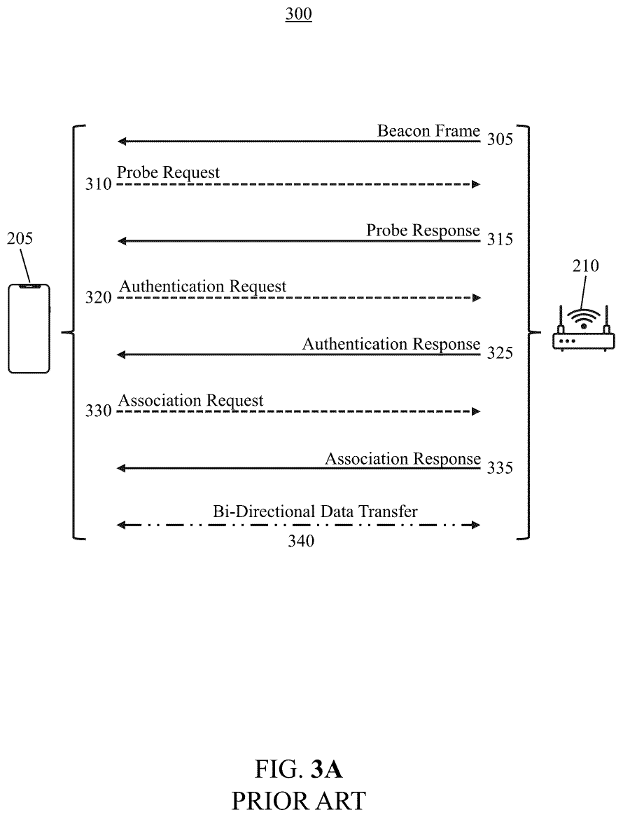

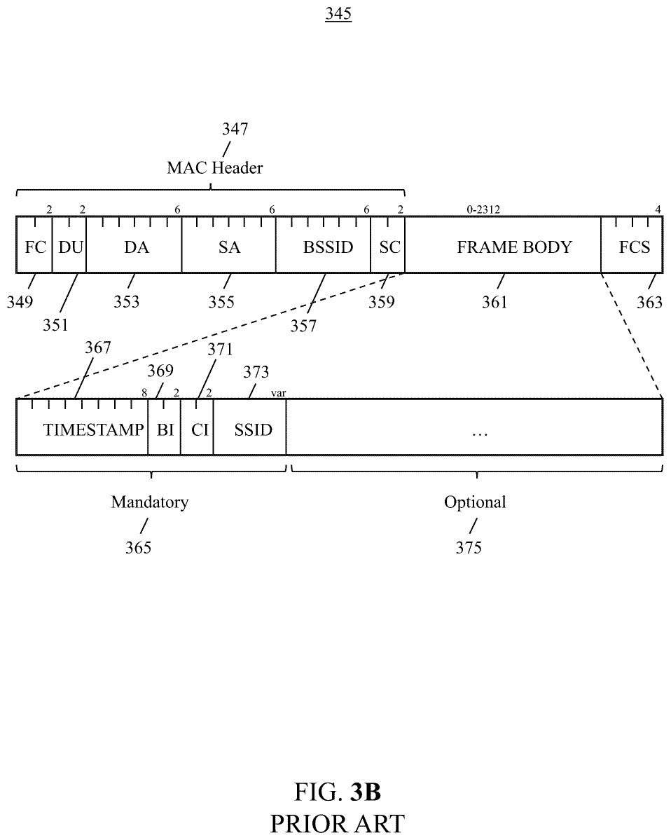

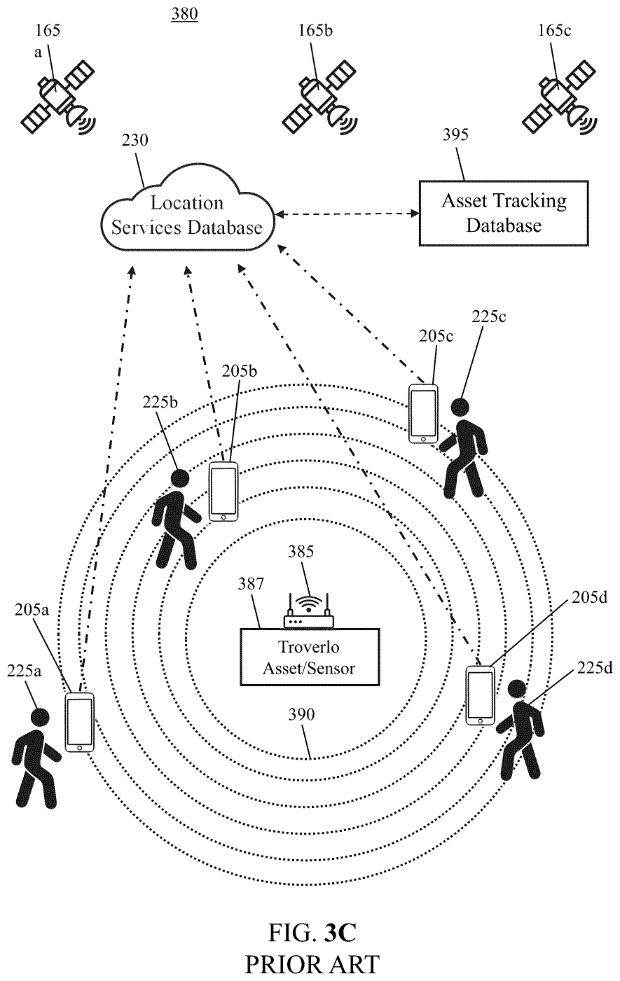

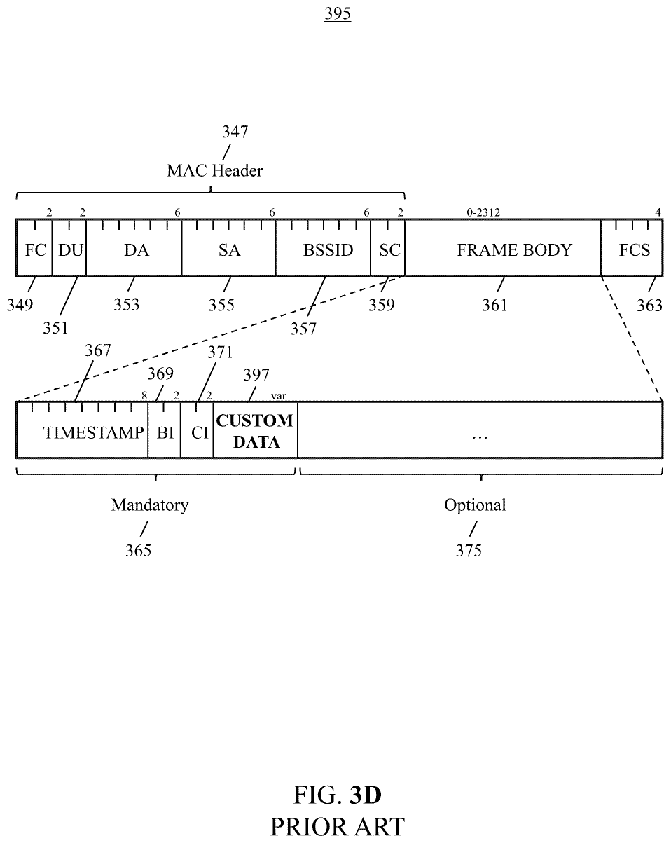

FIG. 3A shows a diagram of a conventional Wi-Fi wireless network discovery protocol 300 between a wireless device 205 and a Wi-Fi access point 210 that underlies Wi-Fi location determination.

The Institute of Electrical and Electronic Engineers (“IEEE”) 802.11 standard includes a Wi-Fi wireless network discovery protocol where Wi-Fi access points (e.g., 210) periodically broadcast beacon frames 305 to announce the presence of a Wireless Local Area Network (“WLAN”) to wireless devices 205 that happen to come into signaling range. Similarly, wireless device 205 may actively scan for the presence of nearby WLANs by broadcasting probe request frames 310 that are received by Wi-Fi access point 210 in signaling range and transmit probe response frames 315 to wireless device 205 in response.

When wireless device 205 receives one or more beacon frames 305 or probe response frames 315 from one or more in-range Wi-Fi access points 210, wireless device 205 may report their encounter with each Wi-Fi access point 210 to its location services database (not shown) and obtain information from the location services database (not shown) regarding the last known locations of each Wi-Fi access points 210 encountered and other information that may be used by wireless device 205 to self-determine its current location. For example, when wireless device 205 comes into signaling range of one or more Wi-Fi access points 210, wireless device 205 receives one or more beacon frames 305 or probe response frames 315 containing information that uniquely identifies each Wi-Fi access point 210, records the information obtained, and reports observations comprising information relating to the encounter, including potentially its current location, to location services of its operating system (which is typically communicated upstream to the location services database). The operating systems of wireless devices 205 collect and report these observations of encounters for the purpose of enhancing the accuracy of the information contained in their respective location services databases (not shown) for future use by others.

The IEEE 802.11 standard specifies three different types of frames that are exchanged between wireless devices during Wi-Fi wireless network discovery: management frames, data frames, and control frames, each of which serves a specific purpose under the protocol. For example, management frames are used for supervisory functions including Wi-Fi wireless network discovery, data frames are used to transmit data once authenticated and associated, and control frames are used to control the transmission of data once authenticated and associated. As noted above, the IEEE 802.11 standard specifies two different scenarios by which a wireless device 205 may identify, authenticate to, and associate with a Wi-Fi access point 210 as part of the Wi-Fi wireless network discovery protocol.

In passive scanning mode, a wireless device 205 listens for beacon frames 305 that are broadcast at periodic intervals by in-range Wi-Fi access points 210. Beacon frames 305 announce the presence of Wi-Fi access point 210 and includes information that facilitates potential authentication to, association with, and ultimately post association data transmission. The information includes, for example, the Basic Service Set Identifier (“BSSID”) and the Service Set Identifier (“SSID”) of the broadcasting Wi-Fi access point 210. For example, the user of a wireless device 205, in this example a smartphone, may open the Wi-Fi application on their device, see a list of SSIDs corresponding to in-range Wi-Fi access points 210 that are broadcasting their respective beacon frames (e.g., 305), and select a particular SSID of the Wi-Fi wireless network they wish to join. When the user selects the SSID of a particular Wi-Fi access point 210, the wireless device 205 transmits a probe request frame 310, another type of management frame, to the particular Wi-Fi access point 210 that includes the capabilities of wireless device 205.

In the active scanning mode, without necessarily having received a beacon frame 305, wireless device 205 may scan for nearby Wi-Fi access points 210 by transmitting a probe request frame 310 that includes the capabilities of wireless device 205 to a specific Wi-Fi access point 210 or all in-range Wi-Fi access points. As such, the Wi-Fi wireless network discovery protocol may be initiated by a Wi-Fi access point 210 that broadcasts beacon frames 305 or a wireless device 205 that broadcasts probe request frames 310. Regardless of which, the remainder of the authentication and association portions of the wireless network discovery protocol is substantially the same.

Subsequent to receipt of a probe request frame 310, if Wi-Fi access point 210 has compatible parameters, Wi-Fi access point 210 transmits a probe response frame 315, another type of management frame, to wireless device 205. Probe response frame 315 includes the parameters typically included in beacon frame 305 including unique identifying information and capabilities of Wi-Fi access point 210. It is important to note that, at this stage of the process, wireless device 205 is not authenticated to, and not associated with, Wi-Fi access point 210, and is not capable of transmitting data in post-authentication data frames 340. Subsequent to receipt of probe response frame 315, wireless device 205 transmits an authentication request frame 320, another type of management frame, to Wi-Fi access point 210. The authentication protocol establishes whether wireless device 205 is authenticated to Wi-Fi access point 210, vis-á-vis, ensuring permission or access with respect to encryption (open or shared key encryption). While the details of the authentication protocol are beyond the scope of this discussion, it is important to note that a wireless device 205 typically cannot proceed to association and post-association data transfer until it is has been successfully authenticated to Wi-Fi access point 210, as signified by an authentication response frame 325, another type of management frame, acknowledging successful authentication.

Once authenticated to Wi-Fi access point 210, wireless device 205 transmits an association request frame 330, another type of management frame, to Wi-Fi access point 210. Association request frame 330 signifies a request by the authenticated, but as yet unassociated wireless device 205 to associate with Wi-Fi access point 210 so as to enable post-association data transfer via data frames 340. Association request frame 330 includes information including, for example, capabilities of wireless device 205. After receipt of association request frame 330, Wi-Fi access point 210 compares the capabilities set out in association request frame 330 with the capabilities of Wi-Fi access point 210 to determine if they match. If there is a substantive mismatch, Wi-Fi access point 210 determines whether the differences are an issue that prevents association and data transfer. If the differences are not substantive, Wi-Fi access point 210 transmits an association response frame 335, another type of management frame, acknowledging successful association. Once association response frame 335 is received, signifying successful association with Wi-Fi access point 210, wireless device 205 may exchange post-association data 340 with Wi-Fi access point 210 in data frames 340 that are routed over a bridged network connection, typically the Internet, to its final destination. It is important to note that, in order for a wireless device 205 to transmit post-association data 340 with Wi-Fi access point 210, other than management frames, wireless device 205 must authenticate to, and associate with, Wi-Fi access point 210, thereby enabling wireless device 205 to transmit and receive non-protocol related data 340. And similarly, Wi-Fi access point 210 cannot transfer non-protocol related data in data frames 340 to wireless device 205 unless and until wireless device 205 has authenticated to, and associated with, Wi-Fi access point 210.

Continuing, FIG. 3B shows a diagram of a conventional Wi-Fi management frame 345 used as part of the conventional Wi-Fi wireless network discovery protocol.

A conventional Wi-Fi management frame 345, such as, for example, a beacon frame (e.g., 305 of FIG. 3A) or probe response frame (e.g., 315 of FIG. 3A), includes predetermined fields that are defined by the specification for their protocol-defined purpose. For example, MAC header 347 of management frame 345, includes Frame Control (“FC”) field 349, Duration (“DU”) field 351, Destination Address (“DA”) field 353, Source Address (“SA”) field 355, BSSID 357, and Sequence Control (“SC”) field 359. Management frame 345 further includes the Frame Body field 361 that includes a number of subfields, including some that may vary based on the subtype of management frame 345. For example, Frame Body 361 includes mandatory subfields 365 including Timestamp subfield 367, Beacon Interval (“BI”) subfield 369, Compatibility Information (“CI”) subfield 371, SSID subfield 373, and potentially Supported Rates subfield (not shown). Frame Body field 361 may also include one or more optional subfields 375 that also may vary based on the subtype of management frame 345. The end of management frame 345 includes a Frame Check Sequence (“FCS”) field 363 that includes an error-detecting code. Under the Wi-Fi wireless network discovery protocol, beacon frames (e.g., 305 of FIG. 3A), probe response frames (e.g., 315 of FIG. 3A), and other management frames are in the form of conventional management frame 345, for the purpose of furthering identification, authentication to, and association with, a Wi-Fi access point (e.g., 210 of FIG. 3A).

Continuing, FIG. 3C shows a diagram of Troverlo, Inc.'s passive asset or sensor tracking 380 using observations of a Wi-Fi access point (e.g., 385) associated with an asset (e.g., 387) and location services. Troverlo, Inc. of College Station, Texas, is the owner of U.S. Pat. Nos. 10,728,709, 10,841,749, 10,848,934, 10,848,935, 11,589,187, 11,622,234, 11,917,488, and 11,950,170 that disclose methods and systems of passive asset or sensor tracking using existing infrastructure, each of which are hereby incorporated by reference in their entirety.

Troverlo, Inc.'s passive asset or sensor tracking methods leverage the already existing ecosystem of wireless devices (e.g., smartphones) and supporting infrastructure (e.g., Wi-Fi access points and location services databases), as a passive asset or sensor tracking network, without requiring the participation of, or even an awareness on the part of, any particular user, wireless device, or Wi-Fi access point that they are participating in the asset or sensor tracking task. In this way, Troverlo, Inc.'s passive asset or sensor tracking methods leverage the existing infrastructure of the world passively, without their awareness, as the asset or sensor tracking network, with no costs imposed for having done so. Troverlo, Inc.'s methods and systems are passive in the sense that they do not require the deployment of dedicated asset tag readers and leverage existing and unrelated wireless devices already in the field to passively track assets or sensors via indirect reporting by these wireless devices to their respective location services databases as part of the normal operation of location services. Effectively, the universe of smartphones and other wireless devices are used as a passive asset or sensor tracking network that spans the globe. Not only does this reduce or eliminate costs associated with the asset or sensor tracking task, but enlarges the breadth of coverage area to anywhere in the world that smartphones or other wireless devices exist.

Whenever a wireless device (e.g., 205a, 205b, 205c, 205d) encounters a Wi-Fi access point 385 associated with an asset387, the wireless device (e.g., 205a, 205b, 205c, 205d) reports the encounter with Wi-Fi access point 385 associated with asset 387, which it merely views as another conventional Wi-Fi access point, to the location services database 230 for its intended purpose, namely, location services.

However, Troverlo Inc.'s passive asset or sensor tracking methods leverage the fact that the conventional report of the encounter to location services database 230 includes the unique identifying information of Wi-Fi access point 385 associated with asset 387as well as location information contained in the Wi-Fi wireless network discovery protocol management frame (e.g., 395 of FIG. 3D). The unique identifying information of Wi-Fi access point 385 associated with asset 387 is associated with the asset in an asset or sensor tracking database 395 typically maintained by Troverlo. Asset tracking database 395 may then request the location of Wi-Fi access point 385 associated with asset 387 from location services database 230, which includes the unique identifying information of Wi-Fi access point 385 associated with asset 387 as well as location information of Wi-Fi access point 385 associated with asset 387, which may be used as a proxy for the location of the asset itself (and potentially convey sensor or other data).

In this way, Troverlo, Inc.'s passive asset or sensor tracking methods leverage the fact that wireless devices (e.g., 205a, 205b, 205c, 205d) report observations of encounters with Wi-Fi access points (including Wi-Fi access point 385 associated with asset 387) to location services databases 230 and use this existing infrastructure in an unconventional and counterintuitive manner to covertly track assets or sensors, with the asset or sensor tracking task being carried out by random wireless devices (e.g., 205a, 205b, 205c, 205d) that merely happen to encounter Wi-Fi access point 385 associated with asset 387—making the universe of smartphones, a passive asset or sensor tracking network. Put another way, there is no requirement for dedicated devices, such as asset tag readers, to track the location of assets. The world of pre-existing infrastructure (including Wi-Fi access points and wireless devices) serves as the passive asset or sensor tracking network.

For purposes of illustration, Wi-Fi access point 385 may be disposed on, otherwise attached to, or integrated with an asset 387 that is desired to be tracked. Asset 387 may freely move from one location to another anywhere in the world. Wi-Fi access point 385 associated with asset 387 may transmit a beacon frame, probe response frame, or other management frame as part of Wi-Fi wireless network discovery protocol, without requiring any wireless device (e.g., 205a, 205b, 205c, 205d) to authenticate to, associate with, or otherwise establish network connectivity with Wi-Fi access point 385. Wi-Fi access point 385 associated with asset 387 merely has to participate in at least part of the Wi-Fi wireless network discovery protocol such that a wireless device (e.g., 205a, 205b, 205c, 205d) that happens to encounter Wi-Fi access point 385 associated with asset 387, identifies Wi-Fi access point 385 as a bona fide access point and reports the encounter to location services database 230.

For example, four different users (e.g., 225a, 225b, 225c, 225d) and their respective wireless devices (e.g., 205a, 205b, 205c, 205d) may happen to come within signaling range 390 of Wi-Fi access point 385 associated with asset 387. Without an awareness on the part of any of the users (e.g., 225a, 225b, 225c, 225d), each of their wireless devices (e.g., 205a, 205b, 205c, 205d) may observe and report observations of their respective encounter with Wi-Fi access point 385 associated with asset 387 to their respective location services database 230. Each reported observation may include the unique identifying information of Wi-Fi access point 385 associated with asset 387 encountered, received signal strengths, as well as location information at or near the time of the encounter. In doing so, each and every wireless device (e.g., 205a, 205b, 205c, 205d) that merely comes into range 390 of Wi-Fi access point 385 associated with asset 385, unwittingly reports a sighting of asset 387 as well as location information to location services database 230. While location services database 230 does not recognize this information as anything other than a reported observation of a bona fide Wi-Fi access point, conventionally compiled and used to enhance the precision of location determinations, in this instance, the existing infrastructure is being used by the asset tracking database 395 to unwittingly track the location of the asset 387.

Location services database 230 that receives reports of observations from wireless devices (e.g., 205a, 205b, 205c, 205d) may compile this information to enhance location services provided to other wireless devices, without an awareness on the part of any particular user (e.g., 225a, 225b, 225c, 225d), their wireless device (e.g., 205a, 205b, 205c, 205d), or even location services database 230, that the reported encounter is being used by an asset tracking database 395 to covertly track assets or sensors. Asset tracking database 395 may associate the unique identifying information of Wi-Fi access point 385 associated with asset 387 with a particular moveable asset and may periodically query location services database 230 requesting observations of this particular Wi-Fi access point 385. In this example, there are four recent observations of encounters with Wi-Fi access point 385 associated with asset 387 that were reported to the location services database 230 and transmitted to asset tracking database 395. While location services database 230 may think that it is only transmitting observation information of Wi-Fi access point(s) and their location information, asset tracking database 395 may use the observation data including unique identifying information of Wi-Fi access point 385 associated with asset 387 and its last known location reported by location services database 230 to determine the location of the moveable asset 387, obtain additional data, such as sensor data hidden in other fields of the management frame, and make it available to users of asset tracking database 395.

Inherent in Troverlo, Inc.'s passive asset or sensor tracking methods, is the use of the existing infrastructure to serve as the passive asset or sensor tracking network, without requiring any particular user (e.g., 225a, 225b, 225c, 225d) or wireless device (e.g., 205a, 205b, 205c, 205d) to participate in the asset or sensor tracking task and without an awareness that they or their wireless devices are even participating in the asset or sensor tracking task. Thus, wireless devices (e.g., 205a, 205b, 205c, 205d), other Wi-Fi access points (not shown), and location services database 230 are being used, without their awareness, as a passive asset or sensor tracking network, at no cost. Moveable assets 387 may be deployed anywhere in the world, and anytime a wireless device (e.g., 205a, 205b, 205c, 205d) merely happens to come within signaling range 390, the wireless device (e.g., 205a, 205b, 205c, 205d) reports their encounter to their location services database 230, but in this case, without any awareness on the part of the user (e.g., 225a, 225b, 225c, 225d) or wireless device (e.g., 205a, 205b, 205c, 205d) that they are participating in the passive asset or sensor tracking task. In essence, Troverlo, Inc.'s passive asset and sensor tracking methods use the entire world of wireless devices to unwittingly serve as the asset and sensor tracking network. Troverlo, Inc.'s passive asset and sensor tracking methods do not require dedicated asset tags, asset tag readers, the ability to self-determine their location, the ability to self-report their location, or network connectivity of any kind other than the ability to transmit beacon frames that contain their unique identifying information and potentially other data within fields of the beacon frame that are conventionally reported to location services database 230.

Continuing, FIG. 3D shows a diagram of a Wi-Fi management frame with custom data added in a programmable field for use with Troverlo, Inc.'s passive asset or sensor tracking.

Troverlo, Inc.'s passive asset or sensor tracking methods only require a Wi-Fi access point (e.g., 385 of FIG. 3C) associated with a particular asset (e.g., 387 of FIG. 3C) to participate in, at least part of, Wi-Fi wireless network discovery protocol in order to transmit its unique identifying information and optionally sensor or other data via a beacon frame (e.g., 305 of FIG. 3A), probe response frame (e.g., 315 of FIG. 3A), or other management frame, having the same format as a conventional management frame (e.g., 345 of FIG. 3B). However, the beacon frame (e.g., 305 of FIG. 3A), probe response frame (e.g., 315 of FIG. 3A), or other management frame (e.g., 345 of FIG. 3B), may include sensor or other data in one or more fields of modified management frame 395 transmitted as part of the Wi-Fi wireless network discovery protocol.

In the example depicted, sensor or other data may be disposed in SSID field 397. SSID field 397 may advantageously be used because both beacon frame (e.g., 305 of FIG. 3A) and probe response frames (e.g., 315 of FIG. 3A) transmitted as part of Wi-Fi wireless network discovery include unique identifying information of the Wi-Fi access point encountered, including BSSID 357, and SSID 397, which in this example, may include sensor or other data rather than the name of a WLAN. In this way, additional information may be disposed in certain fields, in either numeric or alphanumeric form, with or without encoding of a beacon frame (e.g., 305 of FIG. 3A), probe response frame (e.g., 315 of FIG. 3A), or other management frame (e.g., 345 of FIG. 3B). While any field of management frame 395 may potentially be used, the one or more fields selected to dispose additional information, such as, for example, sensor or other data, may be selected such that they are field or fields reported by a wireless device (e.g., 205 of FIG. 3C) that encounters the Wi-Fi access point (e.g., 385 of FIG. 3C), typically as part of the inherent reporting feature used for improving location services described above as part of Troverlo, Inc.'s passive asset or sensor tracking methods. Continuing the example depicted, BSSID field 357 may be used to uniquely identify the Wi-Fi access point (e.g., 385 of FIG. 3C) and sensor or other data may be obtained from SSID field 397.

When a wireless device (e.g., 205a, 205b, 205c, 205d of FIG. 3C) merely encounters the Wi-Fi access point (e.g., 385 of FIG. 3C) associated with an asset (e.g., 387 of FIG. 3C), the wireless device (e.g., 205a, 205b, 205c, 205d of FIG. 3C) reports observation data including, at least, BSSID 357 and SSID 397 of the Wi-Fi access point (e.g., 385 of FIG. 3C) associated with the asset (e.g., 387 of FIG. 3C) it encountered to the location services database (e.g., 230 of FIG. 3C). The beacon frame (e.g., 305 of FIG. 3A), probe response frame (e.g., 315 of FIG. 3A), or other management frame (e.g., 345 of FIG. 3B) transmitted by the Wi-Fi access point (e.g., 385 of FIG. 3C) associated with the asset (e.g., 387 of FIG. 3C) may include additional data, such as, for example, sensor or other data, in SSID field 397 (or other fields). A wireless device (e.g., 205a, 205b, 205c, 205d of FIG. 3C) may report observation data including the unique identifying information, BSSID 357, of the Wi-Fi access point (e.g., 385 of FIG. 3C) associated with the asset (e.g., 387 of FIG. 3C) and additional data, such as, for example, sensor or other data, stored within SSID 397 (or other fields), to a location services database (e.g., 230 of FIG. 3C) which is obtained by an asset tracking database (e.g., 395 of FIG. 3C). The use of SSID field 397 is merely exemplary and any other field reported upstream to the location services database (e.g., 230 of FIG. 3C) may be used.

In view of the above, active asset tracking systems require some combination of asset, tag, and reader that are capable of determining and reporting the location of the asset via a network connection to the Internet. For example, in the case of short-range asset tracking systems, an inexpensive asset tag is typically attached to an asset and must be read by an asset tag reader that has the ability to self-determine and self-report its own location as proxy for the asset tag and the asset it is attached to. Similarly, in the case of GPS-enabled assets, the GPS-enabled asset has the ability to self-determine and self-report its own location over a network connection to the Internet, however, this requires a power supply, GPS receiver capabilities, and communications capabilities, which adds substantial cost to each and every asset. Troverlo, Inc.'s introduction of passive asset or sensor tracking leverages the existing infrastructure of wireless devices and location services to indirectly track the location and/or sensor data of an asset associated with a Wi-Fi access point, without requiring network connectivity to the Internet. However, there is no existing solution that can locate, monitor, and obtain data from an asset deployed anywhere in the world, whether it has a network connection to the Internet or not. Consequently, there are many assets that are deployed with the intent of being managed, however, despite best efforts, once they are deployed in the field, they are never heard from again.

Accordingly, in one or more embodiments of the present invention, a method of dual mode asset tracking provides the capability to seamlessly locate, monitor, and obtain data from assets not only when they are in an online mode connected to the Internet, but also when they are in an offline mode disconnected from the Internet. Advantageously, an asset that is desired to be managed may be deployed in the field, move freely anywhere the world, and may still be located, monitored, and data may be obtained from it, whether it has a network connection or not. The ability to locate, monitor, and obtain data from assets whether they are online or offline enhances supply chain and logistics management, enabling the unique ability to receive data related to usage, maintenance, operations, continuous improvement, and other metrics whether the asset is in an online mode with network connectivity to the Internet or in an offline mode without network connectivity to the Internet.

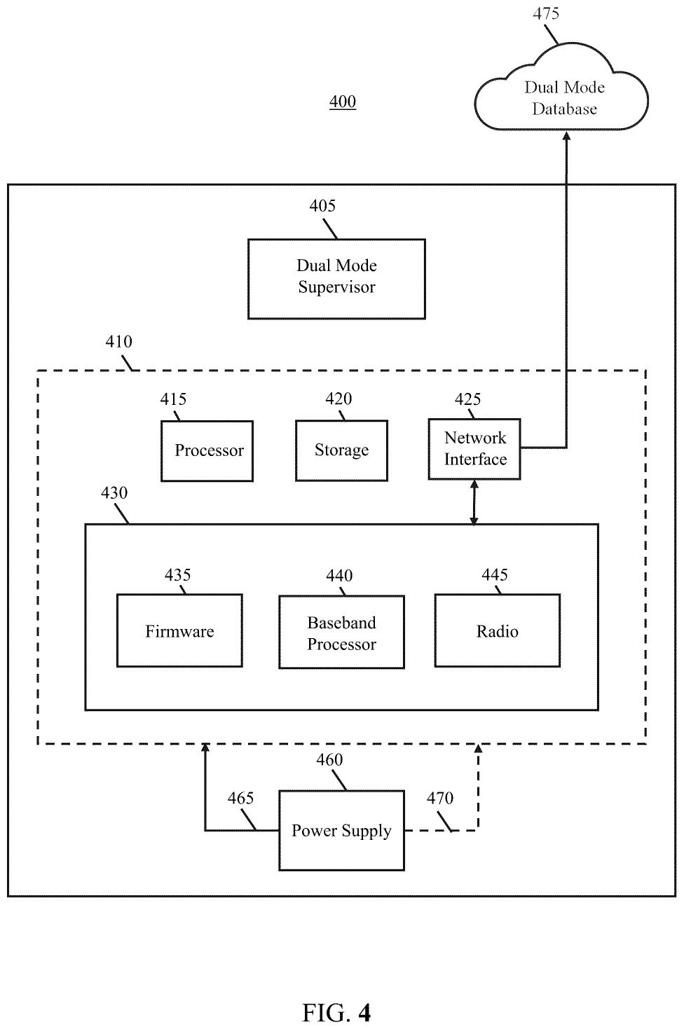

FIG. 4 shows a block diagram of a dual mode asset 400 in accordance with one or more embodiments of the present invention. Dual mode asset 400 may be any type or kind of item that includes, or has access to, computing resources 410 sufficient for executing software instructions comprising dual mode supervisor 405 that performs one or more methods of dual mode asset management in accordance with one or more embodiments of the present invention.

Computing resources 410 may include, for example, a conventional processor 415, storage device 420, network interface device 425, and Wi-Fi interface 430, all of which are well known in the art. Processor 415 may be any type or kind of processor capable of executing software instructions. Storage device 420 may be any type or kind of local storage capable of storing software instructions. Network interface device 425 may be any type or kind of network interface capable of establishing a network connection to dual mode database 475 or other destinations on the Internet. Wi-Fi interface 430 may include firmware 435, baseband processor 440, and radio 445. Firmware 435 may be a fixed storage device comprising software instructions that govern the functionality of Wi-Fi interface 430, baseband processor 440 may be a device that manages the radio functions of Wi-Fi interface 430, and radio 445 may be the air interface of Wi-Fi interface 430, all of which are well known in the art. One of ordinary skill in the art, having the benefit of this disclosure will recognize that, other configurations of computing resources 410 including subsets, supersets, and other combinations of functions and features may be used for a given application or design in accordance with one or more embodiments of the present invention and the example depicted in the figure is merely exemplary of one such embodiment.

Dual mode supervisor 405 may include software instructions that configure one or more computing resources 410 of dual mode asset 400 to switch between an online mode of operation and an offline mode of operation based on the respective presence or absence of a network connection (e.g., 425 or 430) to the Internet or optionally operate in one or more embodiments of a dual mode of operation described herein.

In the online mode of operation there is a network connection (e.g., 425 or 430) to the Internet present and dual mode supervisor 405 may configure dual mode asset 400 to directly report asset related data to dual mode database 475 over the network connection (e.g., 425 or 430). The asset related data may comprise any one or more of unique identifying information of dual mode asset 400, location information of dual mode asset 400, operational status information of dual mode asset 400, historical data of dual mode asset 400, sensor data, or any other data generated or obtained by dual mode asset 400.

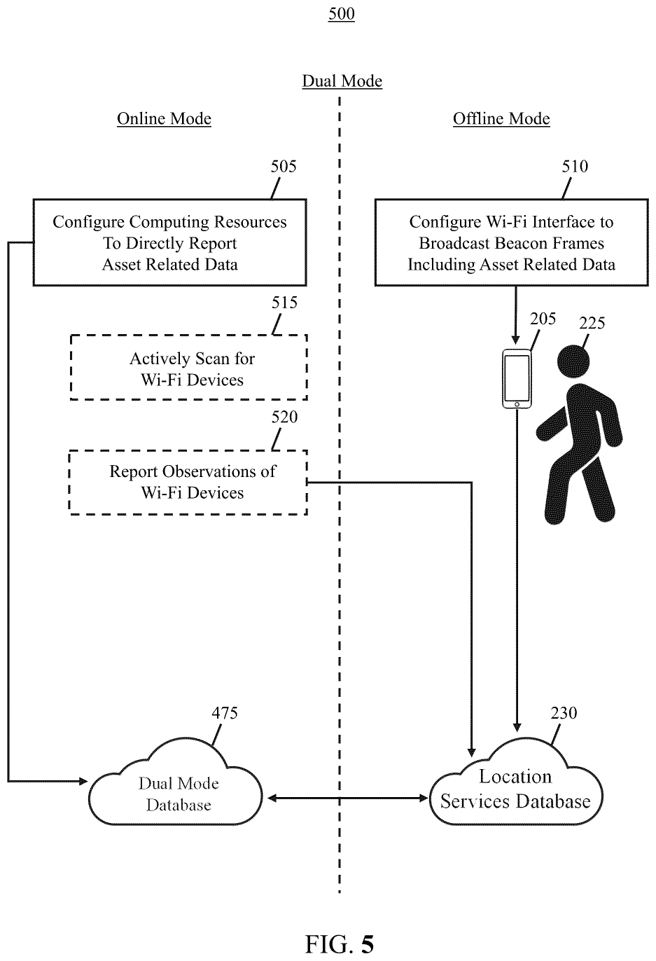

In the offline mode of operation, where there is no network connection to the Internet, dual mode supervisor 405 may configure Wi-Fi interface 430 of dual mode asset 400 to broadcast beacon frames (e.g., 395 of FIG. 3D) that include asset related data embedded in one or more programmable fields, wherein the offline mode of operation relies upon Troverlo, Inc.'s passive asset or sensor tracking (e.g., 380 of FIG. 3C) to indirectly report the asset related data to dual mode database 475 by way of a location services database (e.g., 230 of FIG. 5).

In certain embodiments of a dual mode of operation, dual mode supervisor 405 may configure one or more computing resources 410 of dual mode asset 400 to directly report asset related data to dual mode database 475 over a network connection (e.g., 425 or 430) to the Internet (similar to the online mode of operation discussed above) and configure Wi-Fi interface 430 of dual mode asset 400 to broadcast beacon frames (e.g., 395 of FIG. 3D) comprising asset related data (similar to the offline mode of operation discussed above) at the same time even though there is a network connection to the Internet, where the beacon frames (e.g., 395 of FIG. 3D) may be detected by Troverlo, Inc.'s passive asset or sensor tracking (e.g., 380 of FIG. 3C) that indirectly report the asset related data obtained from the beacon frames (e.g., 395 of FIG. 3D) to dual mode database 475 by way of a location services database (e.g., 230 of FIG. 5). Advantageously, this embodiment of a dual mode of operation provides both direct reporting of asset related data and beaconing of asset related data simultaneously, increasing the likelihood dual mode asset 400 may be remotely located, monitored, managed, and data obtained therefrom, anywhere in the world.

In other embodiments of a dual mode of operation, dual mode supervisor 405 may configure Wi-Fi interface 430 of dual mode asset 400 to actively scan for Wi-Fi devices that come within signaling distance of dual mode asset 400 and report observations of these Wi-Fi devices to a location services database (e.g., 230 of FIG. 5) over a network connection (e.g., 425 or 430) to the Internet (similar to the online mode of operation discussed above) and configure Wi-Fi interface 430 of dual mode asset 400 to broadcast beacon frames (e.g., 395 of FIG. 3D) comprising asset related data (similar to the offline mode of operation discussed above) at the same time even though there is a network connection to the Internet. Advantageously, this embodiment of a dual mode of operation provides both active scanning for in-range Wi-Fi devices and beaconing of asset related data simultaneously.

In still other embodiments of a dual mode of operation, dual mode supervisor 405 may configure Wi-Fi interface 430 of dual mode asset 400 to actively scan for Wi-Fi devices that come within signaling distance of dual mode asset 400 when it does not have a network connection (e.g., 425 or 430) to the Internet and configure Wi-Fi interface 430 of dual mode asset 400 to broadcast beacon frames (e.g., 395 of FIG. 3D) comprising asset related data (similar to the offline mode of operation), at the same time. Dual mode asset 400 may report one or more observations of the scanned Wi-Fi devices to a location services database (e.g., 230 of FIG. 5) at a later time when it has a network connection to the Internet.

The dual mode of operation enables unique management opportunities for assets that are conventionally inaccessible including, for example, remotely locating, monitoring, managing, controlling, and enforcing geographic and security restrictions on these dual mode assets 400. In this way, a dual mode asset 400 voluntarily or involuntarily taken offline cannot hide from the oversight of dual mode database 475 and users thereof and valuable data may be obtained, protected, or wiped from dual mode asset 400 in the event of a security breach.

One of ordinary skill in the art, having the benefit of this disclosure, will recognize that dual mode supervisor 405 may be instantiated as part of firmware 435 of Wi-Fi interface 430 capable of configuring the mode of Wi-Fi interface 430 based on the presence or absence of an Internet connection, an operating system-level device driver (not shown) for Wi-Fi interface 430 stored on storage device 420, or an executable software application (not shown) stored on storage device 420, the implementation of which may vary based on an application or design in accordance with one or more embodiments of the present invention.

In certain embodiments where dual mode asset 400 is powered by a battery (not shown), dual mode asset 400 may include a power supply 460 that provides online power 465 to dual mode asset 400 when operating in the online mode and provides offline power 470 to dual mode asset 400 when operating in the offline mode. Online power 465 may represent the fully powered on state where all functionality is enabled, whereas offline power 470 may represent a lower power state where only those components of dual mode asset 400 that are necessary for offline mode functionality are powered to conserve energy. For example, in the offline mode of operation, dual mode supervisor 405 may configure Wi-Fi interface 430 to broadcast beacon frames (not shown) comprising asset related data for detection and indirect reporting by other wireless devices (not shown), such that only those computing resources 410 necessary for that functionality are powered.

FIG. 5 shows a method 500 of dual mode asset management in accordance with one or more embodiments of the present invention.

In one or more embodiments of the present invention, a dual mode supervisor (e.g., 405 of FIG. 4) may comprise software instructions that when executed perform method 500 of dual asset management as described herein. In certain embodiments, the dual mode supervisor (e.g., 405 of FIG. 4) may be instantiated in firmware (e.g., 435 of FIG. 4) of a Wi-Fi interface (e.g., 430 of FIG. 4). In other embodiments, the dual mode supervisor (e.g., 405 of FIG. 4) may be instantiated in an operating system-level driver for a Wi-Fi interface (e.g., 430 of FIG. 4) potentially stored on local storage (e.g., 420 of FIG. 4). In still other embodiments, the dual mode supervisor (e.g., 405 of FIG. 4) may be instantiated in an executable software application potentially stored on local storage (e.g., 420 of FIG. 4). In still other embodiments, the dual mode supervisor (e.g., 405 of FIG. 4) may be instantiated in in any one or more of firmware (e.g., 435 of FIG. 4) of a Wi-Fi interface (e.g., 430 of FIG. 4), an operating system-level driver for a Wi-Fi interface (e.g., 430 of FIG. 4), and an executable software application. One of ordinary skill in the art having the benefit of this disclosure will recognize that the dual mode supervisor (e.g., 405 of FIG. 4) may be instantiated in any layer or combination of layers in the software hierarchy and may vary based on the needs of a specific application or design in accordance with one or more embodiments of the present invention.

The dual mode supervisor (e.g., 405 of FIG. 4) may include software instructions that configure one or more computing resources (e.g., 410 of FIG. 4) of dual mode asset (e.g., 400 of FIG. 4) to switch between an online mode of operation and an offline mode of operation based on the respective presence or absence of a network connection to the Internet and optionally in one or more embodiments of a dual mode of operation described herein.

In the online mode of operation, the dual mode asset (e.g., 400 of FIG. 4) has a network connection to the Internet. In the offline mode of operation, the dual mode asset (e.g., 400 of FIG. 4) does not have a network connection to the Internet, which represents a common scenario where conventional asset tracking systems lose contact with an asset under management. In the dual mode of operation, the dual mode asset (e.g., 400 of FIG. 4) may perform any two or more of directly reporting asset related data, actively scanning for in-range Wi-Fi devices, and beaconing asset related data simultaneously as discussed herein.

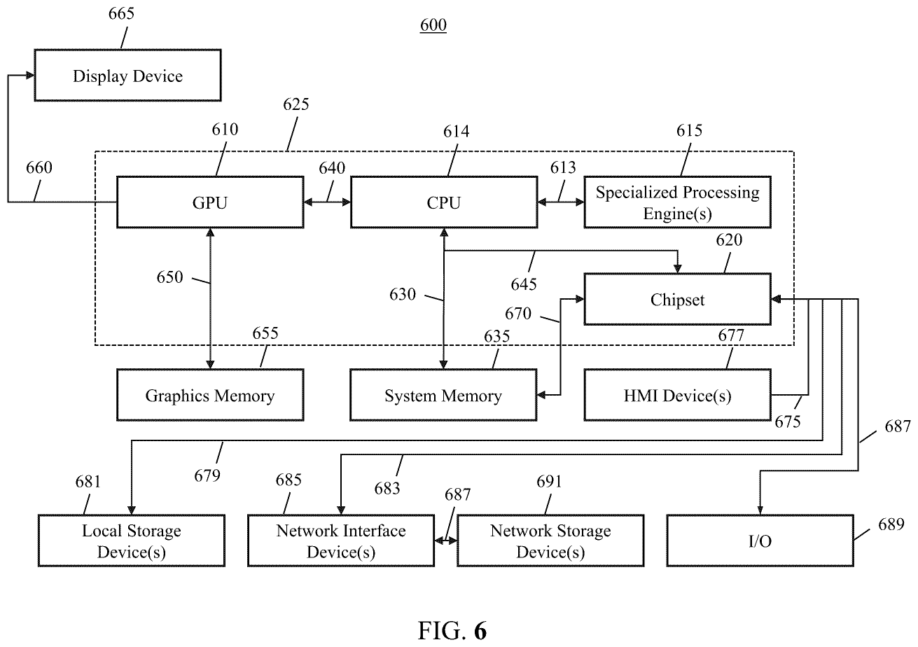

In the online mode of operation, the dual mode supervisor (e.g., 405 of FIG. 4) may configure one or more computing resources (e.g., 410 of FIG. 4) of the dual mode asset (e.g., 400 of FIG. 4) to directly report asset related data to dual mode database 475 over a network connection (e.g., 425 or 430 of FIG. 4) to the Internet. The asset related data may comprise any one or more of unique identifying information of the dual mode asset (e.g., 400 of FIG. 4), location information of the dual mode asset (e.g., 400 of FIG. 4) obtained through any of the well-known location determination techniques available to the dual mode asset (e.g., 400 of FIG. 4), operational status information of the dual mode asset (e.g., 400 of FIG. 4), historical data of the dual mode asset (e.g., 400 of FIG. 4), sensor data, or any other data generated or obtained by the dual mode asset (e.g., 400 of FIG. 4). The computing resources (e.g., 410 of FIG. 4) may include, for example, a conventional processor (e.g., 415 of FIG. 4), storage device (e.g., 420 of FIG. 4), network interface device (e.g., 425 of FIG. 4), and Wi-Fi interface (e.g., 430 of FIG. 4), all of which are well known in the art. The Wi-Fi interface (e.g., 430 of FIG. 4) may include firmware (e.g., 435 of FIG. 4), a baseband processor (e.g., 440 of FIG. 4), and a radio (e.g., 445 of FIG. 4), all of which are well known in the art. Dual mode database 475 may be any type or kind of database that may be stored on a remote computing system (e.g., 600 of FIG. 6) accessible via the Internet. In this context remote means not collocated with the dual mode asset (e.g., 400 of FIG. 4).

In the online mode of operation, the dual mode supervisor (e.g., 405 of FIG. 4) may optionally configure the Wi-Fi interface (e.g., 430 of FIG. 4) of the dual mode asset (e.g., 400 of FIG. 4) to actively scan for Wi-Fi devices 515. In this surveillance mode, the dual mode asset (e.g., 400 of FIG. 4) may actively identify Wi-Fi devices that come within signaling range of the dual mode asset (e.g., 400 of FIG. 4) and one or more computing resources (e.g., 410 of FIG. 4) may report observations of these Wi-Fi devices to location services database 230. The observations may comprise any data obtained from beacon frames (e.g., 345 of FIG. 3B or 395 of FIG. 3D) or probe response frames (e.g., 345 of FIG. 3B or 395 of FIG. 3D) of Wi-Fi devices scanned by the dual mode asset (e.g., 400 of FIG. 4).

In the offline mode of operation, the dual mode supervisor (e.g., 405 of FIG. 4) may configure a Wi-Fi interface (e.g., 430 of FIG. 4) of the dual mode asset (e.g., 400 of FIG. 4) to broadcast beacon frames (e.g., 395 of FIG. 3D) comprising asset related data while the dual mode asset (e.g., 400 of FIG. 4) does not have a network connection to the Internet.

The dual mode supervisor (e.g., 405 of FIG. 4) may place any asset related data in any programmable field of the beacon frame (e.g., 395 of FIG. 3D) that is stored by location services database 230 as part of a reported observation. The asset related data may include any one or more of unique identifying information of the dual mode asset (e.g., 400 of FIG. 4), location information of the dual mode asset (e.g., 400 of FIG. 4), operational status of the dual mode asset (e.g., 400 of FIG. 4), historical data, sensor data, or any other data generated or obtained by the dual mode asset (e.g., 400 of FIG. 4). In the event that the asset related data is larger than can be fit in a single beacon frame (e.g., 395 of FIG. 3D), the dual mode supervisor (e.g., 405 of FIG. 4) may configure the Wi-Fi interface (e.g., 430 of FIG. 4) to broadcast successive beacon frames (e.g., 395 of FIG. 3D) where each frame comprises a portion of asset related data.

The offline mode of operation relies upon Troverlo, Inc.'s passive asset or sensor tracking, as described in detail with reference to FIG. 3, to indirectly report the asset related data to dual mode database 475 by way of location services database 230. When one or more wireless devices 205 come within signaling range of the Wi-Fi interface (e.g., 430 of FIG. 4) of the dual mode asset (e.g., 400 of FIG. 4), one or more wireless devices 205 receive one or more beacon frames (e.g., 395 of FIG. 3D) comprising asset related data and report the observation of the Wi-Fi interface (e.g., 430 of FIG. 4) of the dual mode asset (e.g., 400 of FIG. 4) to location services database 230 via location services of the wireless device 205. In essence, the dual mode asset (e.g., 400 of FIG. 4) is viewed as a Wi-Fi access point and reported as such to location services database 230 for the conventional purpose of location services. Dual mode database 475 may obtain the observations of the dual mode asset (e.g., 400 of FIG. 4) from location services database 230, and thereby obtain the assert related data contained therein, including, for example, its location, status, and any other type or kind of asset related data communicated via the beacon frames (e.g., 395 of FIG. 3D) and stored within location services database 230.

The dual mode asset (e.g., 400 of FIG. 4) may be configured to operate in a dual mode of operation. In certain embodiments, the dual mode supervisor (e.g., 405 of FIG. 4) may configure one or more computing resources (e.g., 410 of FIG. 4) of the dual mode asset (e.g., 400 of FIG. 4) to directly report asset related data to dual mode database 475 over a network connection to the Internet (similar to the online mode of operation discussed above) and configure the Wi-Fi interface (e.g., 430 of FIG. 4) of the dual mode asset (e.g., 400 of FIG. 4) to broadcast beacon frames (e.g., 395 of FIG. 3D) comprising asset related data (similar to the offline mode of operation discussed above) at the same time even though there is a network connection to the Internet. Advantageously, this dual mode of operation provides both direct reporting of asset related data and beaconing of asset related data simultaneously, increasing the likelihood the dual mode asset (e.g., 400 of FIG. 4) may be remotely located, monitored, managed, and data obtained therefrom, anywhere in the world.

In other embodiments, the dual mode supervisor (e.g., 405 of FIG. 4) may configure the Wi-Fi interface (e.g., 430 of FIG. 4) of the dual mode asset (e.g., 400 of FIG. 4) to actively scan for Wi-Fi devices 515 that come within signaling distance of the dual mode asset (e.g., 400 of FIG. 4) and report observations of these Wi-Fi devices to location services database 230 over a network connection to the Internet (similar to the online mode of operation discussed above) and configure the Wi-Fi interface (e.g., 430 of FIG. 4) of the dual mode asset (e.g., 400 of FIG. 4) to broadcast beacon frames (e.g., 395 of FIG. 3D) comprising asset related data (similar to the offline mode of operation discussed above) at the same time even though there is a network connection to the Internet. Advantageously, this dual mode of operation provides both active scanning for in-range Wi-Fi devices and beaconing of asset related data simultaneously.

In still other embodiments, the dual mode supervisor (e.g., 405 of FIG. 4) may configure the Wi-Fi interface (e.g., 430 of FIG. 4) of the dual mode asset (e.g., 400 of FIG. 4) to actively scan for Wi-Fi devices 515 that come within signaling distance of the dual mode asset (e.g., 400 of FIG. 4) when it does not have a network connection to the Internet and configure the Wi-Fi interface (e.g., 430 of FIG. 4) of the dual mode asset (e.g., 400 of FIG. 4) to broadcast beacon frames (e.g., 395 of FIG. 3D) comprising asset related data (similar to the offline mode of operation), at the same time. The dual mode asset (e.g., 400 of FIG. 4) may report one or more observations of the scanned Wi-Fi devices to location services database 230 at a later time when it has a network connection to the Internet.

The dual mode of operation enables unique management opportunities for assets that are conventionally inaccessible including, for example, remotely locating, monitoring, managing, controlling, and enforcing geographic and security restrictions on these assets. In this way, an asset voluntarily or involuntarily taken offline cannot hide from the oversight of dual mode database and valuable data may be obtained, protected, or wiped in the event of a security breach.

Advantageously, a method of dual mode asset management enables for the first time the ability to locate, monitor, manage, and obtain data from an asset (e.g., 400 of FIG. 4) that moves freely anywhere in the world, regardless of whether it has a network connection to the Internet or not.

One of ordinary skill in the art, having the benefit of this disclosure, will recognize that one or more non-transitory computer-readable media may comprise software instructions that, when executed by a processor, may perform one or more of the above-noted methods in accordance with one or more embodiments of the present invention.

FIG. 6 shows a schematic of a computing system 600 in accordance with one or more embodiments of the present invention. Computing system 600 may include one or more central processing units (“CPU”) 614, one or more graphics processing units (“GPU”) 610, and one or more specialized processing engines 615. Computing system 600 may optionally include, if not integrated into CPU 614, a chipset 620 that incorporates one or more functions previously provided by a legacy host bridge (not shown) or input/output (“I/O”) bridge (not shown). In certain embodiments, one or more of the above-noted components may be discrete components. In other embodiments, one or more of the above-noted components, or the functions that they implement, may be integrated into a system-on-chip (“SOC”). An SOC design may include a plurality of one or more of the above-noted components disposed on the same physical die (not shown) or disposed within the same mechanical package (not shown). One of ordinary skill in the art will recognize that the one or more CPUs 614, the one or more GPUs 610, the one or more specialized processing engines 615, and chipset 620 may be integrated, in whole or in part, to reduce the thermal design power (“TDP”), reduce power consumption, reduce chip count, reduce the mechanical footprint, and reduce the complexity of the printed circuit board (“PCB”) (not shown) that they may be disposed on.

Each of the one or more CPUs 614, the one or more GPUs 610, the one or more specialized processing engines 615, and chipset 620 may be a single-core processor (not independently illustrated) or a multi-core processor (not independently illustrated). Multi-core processors typically include a plurality of processor cores (not shown) disposed on the same physical die (not shown) or disposed within the same mechanical package (not shown) that are arranged to provide enhanced capabilities over a single-core implementation. Each of the one or more CPUs 614 may include a memory interface 630 to system memory 635, a graphics interface 650 to the one or more GPUs 610, a specialty interface 613 to the one or more specialized processing engines 615, and a chipset interface 645 to chipset 620. Each of the one or more GPUs 610 may include a CPU interface 640 to the one or more CPUs 614, a memory interface 650 to graphics memory 655, and a display interface 660 to a display device 665. Chipset 620 may include a chipset interface 645 to the one or more CPUs 614, a memory interface 670 to system memory 635, and one or more IO interfaces to one or more IO expansion devices, including, for example, a human/machine interface (“HMI”) interface 675 to one or more HMI devices 677, a local storage interface 679 to one or more local storage devices 681, a network interface 683 to one or more network interface devices 685, and other I/O interfaces 687 to one or more other I/O devices 691.

Each local storage device 681 may be a solid-state memory device, a solid-state memory device array, a hard disk drive, a hard disk drive array, or any other non-transitory computer readable medium. Computing system 600 may also include one or more network-attached storage devices 691 that communicate with one or more network interface devices 685 via a network interface 683. The one or more network-attached storage devices 691 may be used in addition to, or instead of, the one or more local storage devices 681. The one or more network-attached storage devices 691 may be a solid-state memory device, a solid-state memory device array, a hard disk drive, a hard disk drive array, or any other non-transitory computer readable medium. The one or more network-attached storage devices 691 may or may not be collocated with computing system 600 and may be accessible to computing system 600 via one or more network interfaces 683 provided by one or more network interface devices 685. Each network interface device 685 may provide one or more network interfaces including, for example, Ethernet, Fibre Channel, WiMAX, Wi-Fi, Bluetooth, or any other type or kind of network connectivity and network protocol suitable for networked communications.

Computing system 600 may also include one or more application specific integrated circuits (“ASICs”) that are configured to perform a certain function, such as, for example, hashing (not shown), in a more efficient manner. The one or more ASICs may interface directly with the one or more CPUs 614, the one or more GPUs 610, the one or more specialized processing engines 615, and chipset 620.

While computing system 600 has been described above as a general-purpose computing device, one of ordinary skill in the art will recognize that computing system 600 may be reduced to only those components necessary to perform a desired function or scaled up as needed to meet requirements. As such, any of the above-noted components, or various subsets, supersets, or combinations of functions or features thereof, may be integrated, in whole or in part, or distributed among various devices based on an application, design, or form factor in accordance with one or more embodiments of the present invention. As such, the description of computing system 600 is merely exemplary and not intended to limit the type, kind, or configuration of components that constitute a computing system suitable for performing computing operations.

In certain embodiments, computing system 600 may be implemented as a specialized industrial system, a server, a workstation, a desktop computer, a laptop computer, a netbook, a tablet, a smartphone, a mobile device, and/or any other type or kind of computing system in accordance with one or more embodiments of the present invention. In other embodiments, computing system 600 may be instantiated as a virtual computer (not shown) in a virtual or cloud-based infrastructure such as those provided by, for example, Amazon AWS®, Microsoft Azure®, Google Cloud®, or other cloud computing service providers. In such embodiments, the components of computing system 600 may be distributed in a manner that is transparent, but potentially unknown, to the end user. Advantageously, virtualization provides physical isolation, fault tolerance, redundancy, and automated backup mechanisms that protect the integrity of data stored therein.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should only be limited by the appended claims.

What is claimed is:

1. A dual mode asset comprising:
a plurality of computing resources comprising a processor, a storage device, a network interface device, a Wi-Fi interface, and a power supply;
a dual mode supervisor comprising software instructions that, when executed by the processor configures one or more computing resources of the dual mode asset to directly report asset related data to a dual mode database over a network connection to the Internet while the dual mode asset is in an online mode of operation, and configures the Wi-Fi interface of the dual mode asset to broadcast beacon frames comprising asset related data while the dual mode asset is in an offline mode of operation with no network connection to the Internet,
wherein the offline mode of operation relies upon passive asset or sensor tracking to indirectly report the asset related data to the dual mode database by way of location services.

2. The dual mode asset of claim 1, wherein passive asset or sensor tracking comprises one or more wireless devices come within signaling range of the Wi-Fi interface, receive one or more beacon frames from the Wi-Fi interface comprising asset related data, and report one or more observations of the Wi-Fi interface to a location services database via location services and wherein the dual mode database obtains one or more observations of the Wi-Fi interface from the location services database.

3. The dual mode asset of claim 2, wherein the one or more observations of the Wi-Fi interface comprise asset related data including one or more of unique identifying information, location information, operational status, historical data, sensor data, or any other data generated or obtained by the dual mode asset.

4. The dual mode asset of claim 1, further comprising:
configuring, via the dual mode supervisor, the Wi-Fi interface of the dual mode asset to actively scan for and report one or more observations of Wi-Fi devices that come within signaling range of the dual mode asset to the dual mode database while the dual mode asset is in the online mode of operation.

5. The dual mode asset of claim 4, wherein the one or more observations of Wi-Fi devices that come within signaling range of the dual mode asset comprise data obtained from beacon frames or probe response frames of Wi-Fi devices scanned by the dual mode asset.

6. The dual mode asset of claim 1, wherein in a dual mode of operation the dual mode supervisor configures one or more computing resources of the dual mode asset to directly report asset related data to the dual mode database over the network connection to the Internet and also configures the Wi-Fi interface of the dual mode asset to broadcast beacon frames comprising asset related data.

7. The dual mode asset of claim 1, wherein in a dual mode of operation the dual mode supervisor configures the Wi-Fi interface of the dual mode asset to actively scan for Wi-Fi devices that come within signaling range of the dual mode asset and also broadcast beacon frames comprising asset related data, whether there is a network connection to the Internet or not.

8. The dual mode asset of claim 7, wherein one or more computing resources of the dual mode asset report one or more observations of the Wi-Fi devices to the dual mode database when it has a network connection to the Internet.

9. The dual mode asset of claim 1, further comprising:
receiving, at the dual mode supervisor, location information of the dual mode asset.

10. The dual mode asset of claim 1, wherein asset related data comprises one or more of unique identifying information, location information, operational status, historical data, sensor data, or any other data generated or obtained by the dual mode asset.

11. The dual mode asset of claim 1, wherein the dual mode supervisor configures the Wi-Fi interface to broadcast successive beacon frames wherein each frame comprises a portion of asset related data that cannot fit in a single frame.

12. A dual mode asset management system comprising:
a dual mode asset comprising:
a plurality of computing resources comprising a processor, a storage device, a network interface device, a Wi-Fi interface, and a power supply;
a dual mode supervisor comprising software instructions that, when executed by the processor configures one or more computing resources of the dual mode asset to directly report asset related data to a dual mode database over a network connection to the Internet while the dual mode asset is in an online mode of operation, and configures the Wi-Fi interface of the dual mode asset to broadcast beacon frames comprising asset related data while the dual mode asset is in an offline mode of operation with no network connection to the Internet, wherein the offline mode of operation relies upon passive asset or sensor tracking to indirectly report the asset related data to the dual mode database by way of location services.
a dual mode database accessible via the Internet that directly receives reports of asset related data from the dual mode asset while the dual mode asset is in the online mode of operation, and indirectly receives reports of asset related data from the dual mode asset via location services while the dual mode asset is in the offline mode of operation.

13. The dual mode asset management system of claim 12, wherein the dual mode database is accessible via the Internet.

14. The dual mode asset management system of claim 13, wherein passive asset or sensor tracking comprises one or more wireless devices come within signaling range of the Wi-Fi interface, receive one or more beacon frames from the Wi-Fi interface comprising asset related data, and report one or more observations of the Wi-Fi interface to a location services database via location services and wherein the dual mode database obtains one or more observations of the Wi-Fi interface from the location services database.

15. The dual mode asset management system of claim 14, wherein the one or more observations of the Wi-Fi interface comprise asset related data including one or more of unique identifying information, location information, operational status, historical data, sensor data, or any other data generated or obtained by the dual mode asset.

16. The dual mode asset management system of claim 12, further comprising:
configuring, via the dual mode supervisor, the Wi-Fi interface of the dual mode asset to actively scan for and report one or more observations of Wi-Fi devices that come within signaling range of the dual mode asset to the dual mode database while the dual mode asset is in the online mode of operation.

17. The dual mode asset management system of claim 16, wherein the one or more observations of Wi-Fi devices that come within signaling range of the dual mode asset comprise data obtained from beacon frames or probe response frames of Wi-Fi devices scanned by the dual mode asset.

18. The dual mode asset management system of claim 12, wherein in a dual mode of operation the dual mode supervisor configures one or more computing resources of the dual mode asset to directly report asset related data to the dual mode database over the network connection to the Internet and also configures the Wi-Fi interface of the dual mode asset to broadcast beacon frames comprising asset related data.

19. The dual mode asset management system of claim 12, wherein in a dual mode of operation the dual mode supervisor configures the Wi-Fi interface of the dual mode asset to actively scan for Wi-Fi devices that come within signaling range of the dual mode asset and also broadcast beacon frames comprising asset related data, whether there is a network connection to the Internet or not.

20. The dual mode asset management system of claim 19, wherein one or more computing resources of the dual mode asset report one or more observations of the Wi-Fi devices to the dual mode database when it has a network connection to the Internet.

21. The dual mode asset management system of claim 12, further comprising:
receiving, at the dual mode supervisor, location information of the dual mode asset.

22. The dual mode asset management system of claim 12, wherein asset related data comprises one or more of unique identifying information, location information, operational status, historical data, sensor data, or any other data generated or obtained by the dual mode asset.

23. The dual mode asset management system of claim 12, wherein the dual mode supervisor configures the Wi-Fi interface to broadcast successive beacon frames wherein each frame comprises a portion of asset related data that cannot fit in a single frame.
